(19) United States
(12) Patent Application Publication
(10) Pub. No.: US 2026/0125101 A1
(43) Pub. Date: May 7, 2026

(54) CONDUCTIVE CLOTH, STEERING WHEEL ON WHICH THE CONDUCTIVE CLOTH IS MOUNTED, AND MANUFACTURING METHOD OF THE STEERING WHEEL

(71) Applicants: TOYODA GOSEI CO., LTD., Kiyosu-shi, (JP); SEIREN CO., LTD., Fukui-shi, (JP)

(72) Inventors: Masaaki IEDA, Aichi (JP); Shintaro NAKAMURA, Aichi (JP); Junichi IEDA, Aichi (JP); Arata NAKAYAMA, Aichi (JP); Toshinori SASAJI, Fukui (JP)

(21) Appl. No.: 19/381,096

(22) Filed: Nov. 6, 2025

(30) Foreign Application Priority Data
Nov. 7, 2024 (JP) 2024-194887
Oct. 31, 2025 (JP) 2025-184189

(51) Int. Cl. B62D 1/06; D03D 1/00

(52) U.S. Cl. CPC B62D 1/06; D03D 1/0088; D10B 2401/16

(57) ABSTRACT

A conductive cloth is used for a steering wheel mounted on a moving body. The conductive cloth has a fabric having conductivity and made of yarn including crimped yarn. In a state where the conductive cloth is attached to a rim body of the steering wheel, a density of the fabric at a position corresponding to a seam portion of a skin of the steering wheel is higher than a density of the fabric at a position corresponding to a portion of the skin excluding the seam portion.

### CROSS-REFERENCE TO RELATED APPLICATIONS

This application is based on and claims priority under 35 USC 119 from Japanese Patent Applications No. 2024-194887 filed on Nov. 7, 2024 and No. 2025-184189 filed on Oct. 31, 2025, the entire content of which is incorporated herein by reference.

### TECHNICAL FIELD

The present disclosure relates to a conductive cloth, a steering wheel on which the conductive cloth is mounted, and a manufacturing method of the steering wheel.

### BACKGROUND ART

Various types of steering devices equipped with a sensor for detecting a grip by an occupant have been proposed. For example, JP2022-026032A discloses a steering wheel including a sensor layer including a conductive knitted material. The sensor layer is covered with a skin.

The skin is fixed by sewing together end portions of the skin member and covers the sensor layer. The seam portion is thicker than other portions of the skin in order to secure the seam allowance. Therefore, it is concerned that the sensitivity of the sensor for gripping detection in the seam portion may decrease.

### SUMMARY OF INVENTION

The present invention can be implemented as the following aspects.

According to an aspect of the present disclosure, a conductive cloth used for a steering wheel mounted on a moving body is provided. The conductive cloth includes a fabric that has conductivity and is made of yarn including crimped yarn. In a state where the conductive cloth is attached to a rim body of the steering wheel, a density of the fabric at a position corresponding to a seam portion of a skin of the steering wheel is higher than a density of the fabric at a position corresponding to a portion of the skin excluding the seam portion.

According to the conductive fabric of the aspect, since the density of the fabric at the position corresponding to the seam portion is higher than the density of the fabric at the position corresponding to the skin portion excluding the seam portion, it is possible to suppress a decrease in sensor sensitivity at the seam portion.

In addition, since the fabric is made of the yarn including the crimped yarn, the fabric is likely to expand and contract as compared with a configuration in which the yarn does not include the crimped yarn. Accordingly, the density difference of the fabric in the conductive fabric can be easily provided, and the density of the fabric at the position corresponding to the seam portion can be easily increased.

In addition, since the conductive cloth includes the fabric, it is possible to suppress the conductive cloth from losing its shape as compared with a configuration in which the conductive cloth does not include the fabric and is formed of a knitted material only.

The present disclosure can be implemented in various aspects. For example, the present disclosure is realized in forms such as a steering wheel on which the conductive cloth is mounted, a moving body on which the steering wheel is mounted, and a manufacturing method of the steering wheel.

### BRIEF DESCRIPTION OF DRAWINGS

Exemplary embodiment(s) of the present invention will be described in detail based on the following figures, wherein:

FIG. 1 is a front view of a steering wheel according to an embodiment of the present disclosure;

FIG. 2 is a cross-sectional view of a rim portion taken along line II-II in FIG. 1; and

FIG. 3 is a flowchart showing a procedure of a manufacturing method of the steering wheel.

### DESCRIPTION OF EMBODIMENTS

### A. Embodiment

### (A1. Device Configuration)

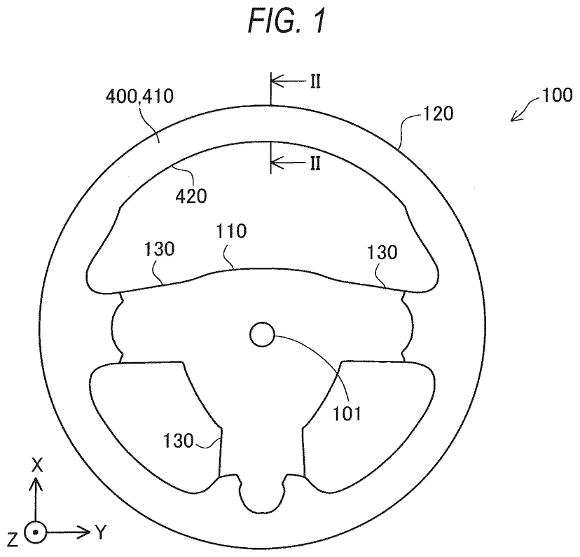

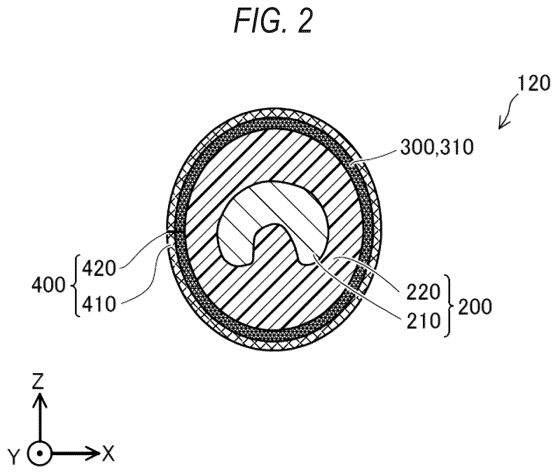

FIG. 1 is a front view of a steering wheel 100 according to an aspect of the present disclosure. An X axis, a Y axis, and a Z axis illustrated in FIGS. 1 and 2 are axes indicating directions intersecting each other at 90-degree angle. In the present embodiment, the Y axis is parallel to the left-right direction of a vehicle, and the Z axis is parallel to a rotation shaft 101. The steering wheel 100 in the present embodiment is mounted on the vehicle and is used to indicate a traveling direction of the vehicle. The steering wheel 100 includes a hub portion 110, a rim portion 120, and a spoke portion 130. The hub portion 110 is located at the center of the steering wheel 100 in a front view thereof, and is connected to the rotation shaft 101 of the vehicle. The rim portion 120 is provided to surround the hub portion 110. The rim portion 120 is gripped by an occupant who steers the vehicle. The rim portion 120 in the present embodiment has an annular external shape. The spoke portion 130 connects the hub portion 110 and the rim portion 120 to each other. The spoke portion 130 is provided with a functional member such as a switch.

FIG. 2 is a cross-sectional view of the rim portion 120 taken along line II-II in FIG. 1. The rim portion 120 includes a rim body 200, a conductive cloth 300, and a skin 400.

The rim body 200 includes a rim core metal 210 and a cushion portion 220. The rim core metal 210 is a framework of the rim portion 120. The rim core metal 210 has a U shape protruding to the outer circumference side of the steering wheel 100 (in a direction away from the rotation shaft 101) in a cross section parallel to the rotation shaft 101 and passing through the rotation shaft 101. The rim core metal 210 is made of metal. The cushion portion 220 covers the rim core metal 210. In the present disclosure, “covering” means both a case where members are in contact with each other and a case where another member is sandwiched between the members. That is, the cushion portion 220 and the rim core metal 210 may be in direct contact, or any member such as an adhesive member may be sandwiched between the cushion portion 220 and the rim core metal 210. The cushion portion 220 is made of an elastic material such as urethane. The cushion portion 220 is molded by, for example, the Reaction Injection Molding (RIM) method.

The conductive cloth 300 covers the rim body 200. The conductive cloth 300 is an electrode of a sensor that detects gripping of the rim portion 120 by the occupant. Note that “detecting gripping” in the present disclosure means detecting not only a state where the occupant gripes the rim portion 120, but also a state where a hand of the occupant is close enough to touch the rim portion 120. The conductive cloth 300 includes a fabric 310 having conductivity. The fabric 310 has a rectangular sheet-like external shape before being attached to the rim body 200. The fabric 310 is made of yarn including crimped yarn. The fabric 310 has conductivity by being plated. The fabric 310 may have conductivity by using conductive threads as the yarn. The fabric 310 is electrically connected to an ECU mounted on the vehicle via a harness.

The crimped yarn is preferably a thermally processed multifilament thread. By heat processing, finer crimps can be formed, and the crimped yarn having bulkiness, stretchability, and elasticity can be obtained. By using such crimped yarn, the stretchability of the fabric 310 can be enhanced.

The crimped yarn preferably has a breaking elongation of 10% or more, more preferably 15% or more, and even more preferably 20% or more. The breaking elongation can be determined as follows in accordance with JIS L1013. The measurement is performed using a tensile tester (AG-I/20 kN-50 kN autograph manufactured by Shimadzu Corporation) under the conditions of a sample yarn length of 20 cm and a constant tensile speed of 20 cm/min, and a sample yarn length (cm) is measured when the maximum value of the load in the load-elongation curve is applied thereto. The elongation percentage (%) is calculated by dividing the yarn length by the sample yarn length (20 cm) before the load is applied. These tests are repeated five times, and the average value of the five measurements is obtained. The average value is the breaking elongation (%).

The material of the crimped yarn is, for example, natural fiber, chemical fiber, synthetic fiber, or a combination thereof. Among these materials, the synthetic fiber is preferable because the synthetic fiber has relatively high resistance to the plating. Polyester-based synthetic fiber is particularly preferable as the synthetic fiber.

The fabric 310 may have any weave texture. Examples of the weave texture include plain weave, twill weave, and satin weave. Among these weave textures, the plain weave is preferable in view of the feature that the deviation of the structure at the time of elongation in an oblique direction is relatively small.

The stretchability of the fabric 310 is not particularly limited, but the tensile strength at 10% elongation in the warp direction and the weft direction is preferably 30 N/cm or less, and more preferably 20 N/cm or less. The tensile strength at 10% elongation is preferably 0.1 N/cm or more, and more preferably 0.2 N/cm or more. The stretchability of the fabric 310 is a value measured according to the B method (grab method) described in 8.14 of JIS L1096: 2010 except that the sample width (grip width) is 10 mm. Conditions at the time of measurement are as follows:
the tester is under constant tension;
the grip interval is 100 mm; and

$$the tensile speed is 150 \pm 10 mm / min .$$

The basis weight of the fabric 310 is preferably 20 g/m² to 230 g/m², and more preferably 30 g/m² to 170 g/m². The metal application amount of the metal coating in the plating is preferably 5 g/m² to 60 g/m², and more preferably 17 g/m² to 43 g/m². The metal application amount is preferably 10% by mass to 60% by mass, and more preferably 17% by mass to 45% by mass, with respect to the total mass of the fabric 310.

The warp density of the fabric 310 is preferably 50 yarns/25.4 mm to 200 yarns/25.4 mm. The weft density of the fabric 310 is preferably 40 yarns/25.4 mm to 200 yarns/25.4 mm. The fabric 310 is more preferably the plain weave having such a weave density.

The skin 400 covers the conductive cloth 300. The skin 400 is touched by the occupant gripping the rim portion 120. The skin 400 includes a skin member 410 and a seam portion 420. The skin member 410 is, for example, sheet-like synthetic leather or natural leather. The seam portion 420 is a portion where margins to sew up the end portions of the skin member 410 are overlapped and sewn with a thread. In the present embodiment, the seam portion 420 is provided along an inner circumference of the rim portion 120 of the steering wheel 100 in a front view of the steering wheel 100. The “inner circumference” of the rim portion 120 in the present disclosure refers to a portion closer to the rotation shaft 101 among portions along the circumferential direction of the rim portion 120 in the front view thereof. In addition, an “outer circumference” of the rim portion 120 refers to a portion farther from the rotation shaft 101 among the portions along the circumferential direction of the rim portion 120 in the front view thereof.

In the present disclosure, the density of the fabric 310 at the position corresponding to the seam portion 420 is higher than the density of the fabric 310 at the position corresponding to the portion of the skin 400 excluding the seam portion 420. Here, since the fabric 310 has conductivity, the fabric 310 at the position corresponding to the seam portion 420 has a relatively large amount of change in charge. That is, the sensitivity of the touch sensor is higher at the position corresponding to the seam portion 420 than at the position corresponding to the portion of the skin 400 excluding the seam portion 420.

### (A2. Manufacturing Method of Steering Wheel 100)

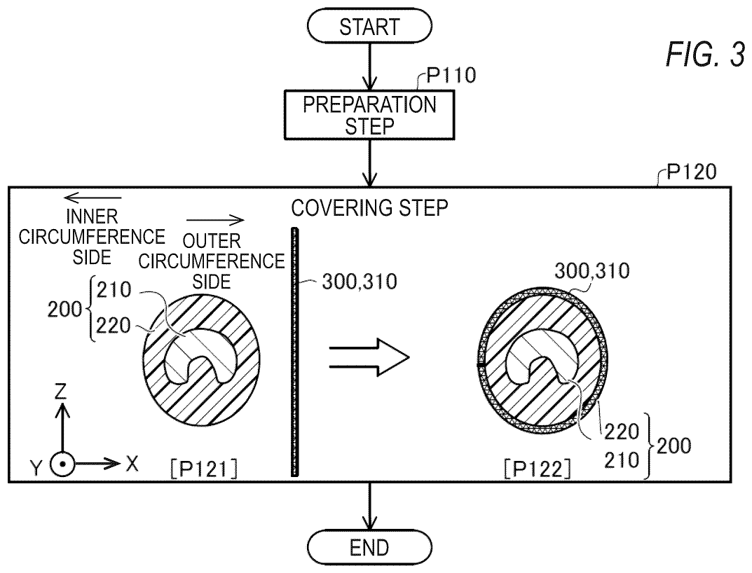

FIG. 3 is a flowchart showing a procedure of a manufacturing method of the steering wheel 100. The manufacturing method of the steering wheel 100 is performed as one step in the manufacturing process of the vehicle. The manufacturing method of the steering wheel 100 includes a preparation step (P110) and a covering step (P120).

In the preparation step (P110), the rim body 200 and the conductive cloth 300 including the fabric 310 which has conductivity and is made of the yarn including the crimped yarn are prepared. An adhesive member is attached in advance to a surface of the conductive cloth 300 on the side covering the rim body 200. Examples of the adhesive member include an adhesive and a double-sided tape. In the covering step (P120), the rim body 200 is covered with the conductive cloth 300 such that the density of the fabric 310 at a planned position corresponding to the seam portion 420 of the skin 400 that covers the conductive cloth 300 in the steering wheel 100 is higher than the density of the fabric 310 at a position corresponding to a portion of the skin 400 excluding the seam portion 420.

As shown in FIG. 1, the seam portion 420 in the present embodiment is provided along the inner circumference of the rim portion 120 in the front view of the steering wheel 100. “P120” in FIG. 3 shows a state where the rim body 200 at a position corresponding to line II-II in FIG. 1 is covered with the conductive cloth 300. In “P120” of FIG. 3, the right side of the rim body 200 in FIG. 3 is the outer circumference side, and the left side of the rim body 200 in FIG. 3 is the inner circumference side. Therefore, the planned position corresponding to the seam portion 420 of the skin 400 is the central portion, in the upper-lower direction of FIG. 3, on the left side of the rim body 200 in FIG. 3. The conductive cloth 300 coats the rim body 200 such that the density of the fabric 310 at the end portion on the lower side in FIG. 3 is higher than the density of the fabric 310 at other portions. Specifically, as shown in step P121 on the left side in P120 of FIG. 3, the sheet-like conductive cloth 300 is arranged such that the central portion in the lateral direction is in contact with the outer circumference side of the rim body 200. Next, as illustrated in step P122 on the right side in P120 of FIG. 3, the portion of the conductive cloth 300, which is to be in contact with the outer circumference side of the rim body 200, is wound around the rim body 200 such that both ends in the lateral direction are arranged at the planned position of the rim body 200 corresponding to the seam portion 420 while being stretched toward the inner circumference.

The density of the conductive cloth 300 with which the rim body 200 is covered in the covering step (P120) is lower in the stretched portion and higher in the other portions. Accordingly, the density of the conductive cloth 300 positioned on the inner circumference side of the rim body 200 is relatively high.

Following step P120, a step of covering the conductive cloth 300 with the skin 400 is performed.

According to the steering wheel 100 of the embodiment described above, since the density of the fabric 310 at the position corresponding to the seam portion 420 is higher than the density of the fabric 310 at the position corresponding to the portion of the skin 400 excluding the seam portion 420, it is possible to suppress a decrease in sensor sensitivity at the seam portion 420.

In addition, according to the steering wheel 100 of the embodiment, since the fabric 310 is made of the yarn including the crimped yarn, the fabric 310 easily expands and contracts as compared with a configuration in which the crimped yarn is not included as the yarn. Accordingly, the density difference of the fabric 310 in the conductive cloth 300 can be easily provided, and the density of the fabric 310 at the position corresponding to the seam portion 420 can be relatively easily increased.

According to the steering wheel 100 of the embodiment, since the conductive cloth 300 includes the fabric 310, it is possible to suppress the conductive cloth 300 from losing its shape as compared with a configuration in which the conductive cloth 300 does not include the fabric 310 and is formed of a knitted material only.

In addition, according to the manufacturing method of the steering wheel 100 of the embodiment, the covering step (P120) includes the step (P121) of arranging the conductive cloth 300 along the outer circumferential surface of the rim body 200, and the step (P122) of stretching the conductive cloth 300 arranged on the outer circumferential surface toward the inner circumference such that the end portions of the conductive cloth 300 are arranged at the planned position of the rim body 200 corresponding to the seam portion 420, and thus the density of the fabric 310 in the seam portion 420 can be easily increased.

### B. Another Embodiment

(B1) In the above-described embodiment, the skin 400 is formed by sewing a single skin member 410, but the present invention is not limited thereto. The skin 400 may be formed by sewing a plurality of skin members 410 together. In the above embodiment, the seam portion 420 is provided along the inner circumference of the rim portion 120, but the present invention is not limited thereto. The seam portion 420 may be provided in any direction in the rim portion 120. For example, the seam portion 420 may be provided along the radial direction of the steering wheel 100.

(B2) In the above embodiment, the steering wheel 100 may further include a heating element used for a grip heater. The heating element is provided to cover the rim body 200, for example.

(B3) In the above-described embodiment, the conductive cloth 300 is used as an electrode of the touch sensor, but the present invention is not limited thereto. The conductive cloth 300 may be used as the heating element of the grip heater.

(B4) In the above embodiment, the rim portion 120 has the annular shape, but the present invention is not limited thereto. The rim portion 120 may have any shape such as a D shape or a butterfly shape.

(B5) In the above embodiment, the steering wheel 100 may be provided in any moving body other than the vehicle. Examples of such a moving body include a ship, an airplane, a spacecraft, and a so-called flying automobile. The moving body is not necessarily limited to an object that realizes actual movement, and may be an object that realizes virtual movement, such as a simulator.

(B6) In the above embodiment, the X axis, the Y axis, and the Z axis may be parallel to arbitrary directions orthogonal to each other.

The present invention is not limited to the above-described embodiments, and can be realized in various configurations without departing from the gist thereof. For example, the technical features in the embodiments corresponding to the technical features in the aspects described in the summary can be appropriately replaced or combined in order to solve some or all of the problems described above or to achieve some or all of the effects described above. In addition, the technical features can be appropriately deleted unless the technical features are described as essential in the present specification.

What is claimed is:

1. A conductive cloth used for a steering wheel mounted on a moving body, the conductive cloth comprising:
a fabric having conductivity and made of yarn including crimped yarn, wherein
in a state where the conductive cloth is attached to a rim body of the steering wheel, a density of the fabric at a position corresponding to a seam portion of a skin of the steering wheel is higher than a density of the fabric at a position corresponding to a portion of the skin excluding the seam portion.

2. A steering wheel on which the conductive cloth according to claim 1 is mounted.

3. A manufacturing method of a steering wheel having a rim portion to be gripped by an occupant of a moving body, the method comprising:
preparing a rim body of the rim portion and a conductive cloth that includes a fabric having conductivity and made of yarn including crimped yarn; and
covering the rim body with the conductive cloth such that a density of the fabric at a planned position corresponding to a seam portion of a skin that covers the conductive cloth in the steering wheel is higher than a density of the fabric at a position corresponding to a portion of the skin excluding the seam portion.

4. The manufacturing method according to claim 3, wherein
the seam portion is provided along an inner circumference of the rim portion in a front view of the steering wheel, and
the covering of the rim body with the conductive cloth includes:
arranging the conductive cloth along an outer circumferential surface of the rim body; and
stretching the conductive cloth arranged on the outer circumferential surface toward the inner circumference such that both end portions of the conductive cloth are arranged at the planned position of the rim body corresponding to the seam portion.
